(19) United States
(12) Patent Application Publication
(10) Pub. No.: US 2017/0343310 A1
(43) Pub. Date: Nov. 30, 2017

(54) METHOD AND APPARATUS FOR FIREARM ACCESS PREVENTION, NOTIFICATION AND TRACKING

(71) Applicant: Joseph Michael REISS, Potomac, MD (US)

(72) Inventor: Joseph Michael REISS, Potomac, MD (US)

(21) Appl. No.: 15/606,589

(22) Filed: May 26, 2017

Related U.S. Application Data
(60) Provisional application No. 62/342,283, filed on May 27, 2016.

(51) Int. Cl. F41A 17/06; G08B 25/12; F41A 17/54

(52) U.S. Cl. CPC F41A 17/063; F41A 17/54; G08B 25/12

(57) ABSTRACT

A method and apparatus of detecting unauthorized use of a firearm owned by a registered user is provided. The method includes using at least one of said at least one processor, movement of the trigger guard lock, transmitting, using at least one of said at least one processor, an alert to a user device informing the user of the detected movement, receiving, using at least one of said at least one processor, a response to the transmitted alert from the user, and unlocking, using at least one of said at least one processor, the trigger guard lock based on the received response.

### CROSS-REFERENCE TO RELATED APPLICATIONS

This application claims priority to and the benefit of U.S. Provisional Application No. 62/342,283, filed May 27, 2016 and entitled “METHOD AND APPARATUS FOR FIREARM ACCESS PREVENTION, NOTIFICATION AND TRACKING,” the contents of which are herein incorporated by reference in their entirety.

### FIELD

The present disclosure is directed to methods and apparatuses for firearm access prevention, notification and tracking. Specifically, the disclosure relates to a trigger guard lock preventing unauthorized usage of and access to a firearm.

### BACKGROUND

Conventional trigger guard locks are mechanical in nature and prevent the user from accessing the trigger by completely blocking access to the trigger guard. However, such trigger guard locks fail to prevent theft of guns, and do not provide any notification to the registered owner regarding unauthorized use or control of the firearm.

Recently, new firearms are being developed with tracking devices built-in to the firearm so that a user can track the firearm using his/her mobile device. However, registered gun owners do not always want their firearms to be track-able and generally prefer the firearm itself not to be fitted with tracking systems. Furthermore, this technology is only being applied to newly manufactured guns and fails to prevent access, or provide tracking and notification features for millions of guns already manufactured and owned by registered users.

Therefore, there is a need for a trigger guard lock which incorporates features that help prevent unauthorized access to a firearm using notification and tracking features, designed to be utilized on existing firearms.

### SUMMARY

According to an aspect of an exemplary embodiment, a method of detecting unauthorized use of a firearm owned by a registered user, performed by a trigger guard lock including at least one processor, the method includes detecting, using at least one of said at least one processor, movement of the trigger guard lock, transmitting, using at least one of said at least one processor, an alert to a user device informing the user of the detected movement, receiving, using at least one of said at least one processor, a response to the transmitted alert from the user, and unlocking, using at least one of said at least one processor, the trigger guard lock based on the received response.

According to another exemplary embodiment, the method of claim 1, wherein the method further includes, if the response is negative, transmitting, using at least one of said at least one processor, an alert to at least one of a pre-designated security company and police, and if the response is positive, unlocking, using at least one of said at least one processor, the trigger guard lock.

According to another exemplary embodiment, the method further includes, if the response is negative, sounding, using at least one of said at least one processor, an alarm.

According to another exemplary embodiment, the transmitting the alert to the user device further comprises transmitting the GPS location of the trigger guard lock to the user device.

According to another exemplary embodiment, the firearm is a gun.

According to an aspect of an exemplary embodiment, a trigger guard lock includes a gyroscope configured to detect movement of the trigger guard lock, a communication unit configured to communicate with at least one user device, a memory containing machine readable medium comprising machine executable code having stored thereon instructions for tracking the movements of the at least one object and a control unit comprising at least one processor coupled to the memory, the control unit configured to execute the machine executable code to cause the control unit to upon detection of movement of the trigger guard lock, transmit an alert to the at least one user device informing the user of the detected movement and receive a response to the transmitted alert from the at least one user device, and unlock the trigger guard lock based on the received response.

According to another exemplary embodiment, if the response is negative, the communication unit further transmits an alert to at least one of a pre-designated security company and police, and if the response is positive, the control unit unlocks the trigger guard lock.

According to another exemplary embodiment, the trigger guard lock further includes an audio unit, configured to, if the response is negative, sound an alarm.

According to another exemplary embodiment, the trigger guard lock further includes, a global positioning system (GPS), wherein the communication unit, using the GPS, further transmits the GPS location of the trigger guard lock to the user device.

According to another exemplary embodiment, the trigger guard lock further includes a fingerprint scanner configured to receive fingerprint scans from a user, wherein the memory is configured to store authorized fingerprints, and the fingerprint scanner authenticates a fingerprint by comparing the fingerprint with fingerprints stored in the memory.

According to an aspect of an exemplary embodiment, a method of controlling a trigger guard lock, using a device including at least one processor and a display, the method includes receiving, using at least one of said at least one processor, an alert from the trigger guard lock, displaying, on the display, the alert, receiving, using at least one of said at least one processor, response from regarding the alert, and transmitting, using at least one of said at least one processor, the response to the trigger guard lock.

According to another exemplary embodiment, the method further includes receiving, using at least one of said at least one processor, GPS location of the trigger guard lock.

According to another exemplary embodiment, the method further includes, if the received response from the user is negative, transmitting, using at least one of said at least one processor, the received GPS location to at least one of a pre-selected security agency and police.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

FIG. 1 illustrates a trigger guard lock, according to an exemplary embodiment.

FIG. 2 illustrates a block diagram representing the depicting the different units within the trigger guard lock, according to an exemplary embodiment.

FIG. 3 illustrates a flowchart depicting the detection and notification process of the trigger guard lock, according to an exemplary embodiment.

FIG. 4 illustrates a flowchart depicting the authentication and notification process of the trigger guard lock, according to an exemplary embodiment.

FIG. 5 illustrates a flowchart depicting the control process of the trigger guard lock from a user device, according to an exemplary embodiment.

In the drawings, the same reference numbers and any acronyms identify elements or acts with the same or similar structure or functionality for ease of understanding and convenience. To easily identify the discussion of any particular element or act, the most significant digit or digits in a reference number refer to the Figure number in which that element is first introduced.

The present disclosure is susceptible to various modifications and alternative forms, and some representative embodiments have been shown by way of example in the drawings and will be described in detail herein. It should be understood, however, that the inventive aspects are not limited to the particular forms illustrated in the drawings. Rather, the disclosure is to cover all modifications, equivalents, and alternatives falling within the spirit and scope of the disclosure as defined by the appended claims.

### DETAILED DESCRIPTION

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other obvious features not described in detail herein. Additionally, some well-known structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations may be depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

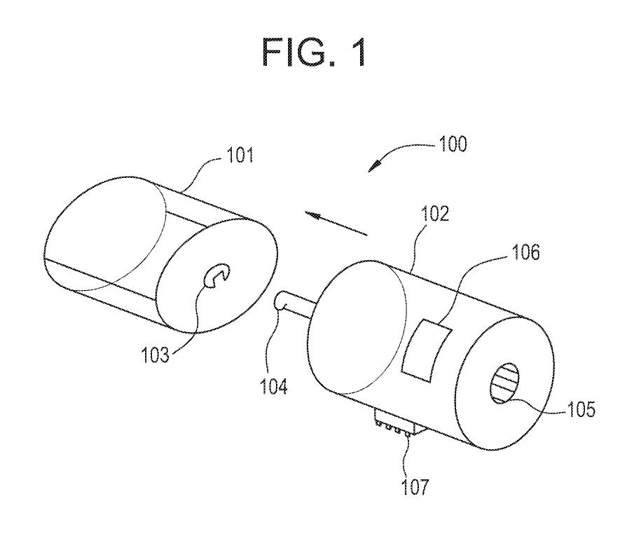

Referring now to the drawings, there is depicted in FIG. 1 an exemplary embodiment of a trigger guard lock 100. The trigger guard lock incorporates a first section 101 and a second section 102. The second section 102 is configured to be inserted into the first section 101 using a protrusion 104 and corresponding entry 103, and lock in place, as depicted in FIG. 1. It should be noted that the depicted embodiment is merely an exemplary embodiment and numerous different configurations of the mechanism may be adopted within the scope of this disclosure.

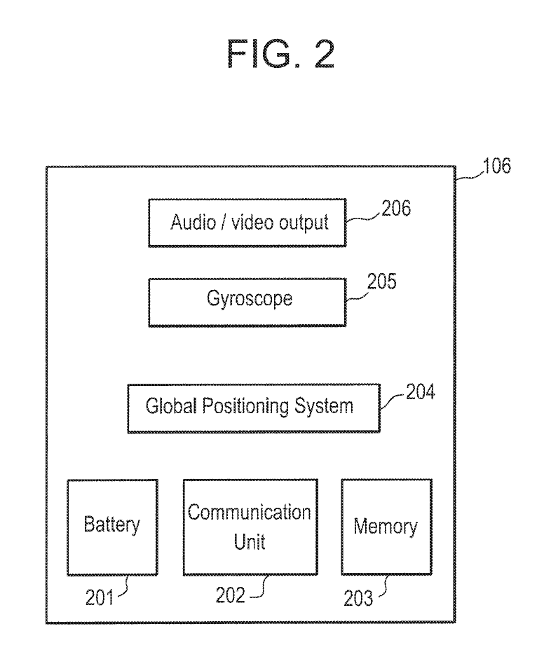

The second section 102 further incorporates a communication and tracking module 106 (described in further detail below with reference to FIG. 2), an unlocking unit 105 and a preference selection unit 107.

The unlocking unit 105 may be a fingerprint scanner, a mechanical combination lock or any other form of unlocking mechanism widely known. The unlocking unit 105 communicates with the communication and tracking module 106 and may be overridden when appropriate instructions are received at the communication and tracking module from a user.

The preference selection unit 107 further provides the user to select preferences regarding notification and tracking. The preference selection unit may be comprised of a binary selection unit, a touch screen for selection of options or any other form of interface that allows a user to communicate with the trigger guard lock 100 to put in preference. The kind of preferences that the user may be able to select can vary and may include selection of whether notifications are to be sent to a user on detection of movement, or on detection of failed unlocking event, or both, selection of whether Global Positioning System (GPS) location is to be sent to the user and more. The user may further select whether notifications are to be sent directly to a pre-selected security company or the police. Numerous other selections are available in the various embodiments.

The features of the communication and tracking module 106 will now be described in greater detail with reference to FIG. 2.

As depicted in FIG. 2, the communication and tracking module 106 may include a battery 201, a communication unit 202, a memory 203, a GPS 204, a gyroscope 205 and an audio/video output unit 206.

The battery 201 may be re-chargeable or disposable and can be of any size and capacity based on the design of the trigger guard lock being developed. The battery powers the fingerprint scanner (if being used as the unlocking unit 105), and all other units within the communication and tracking module 106.

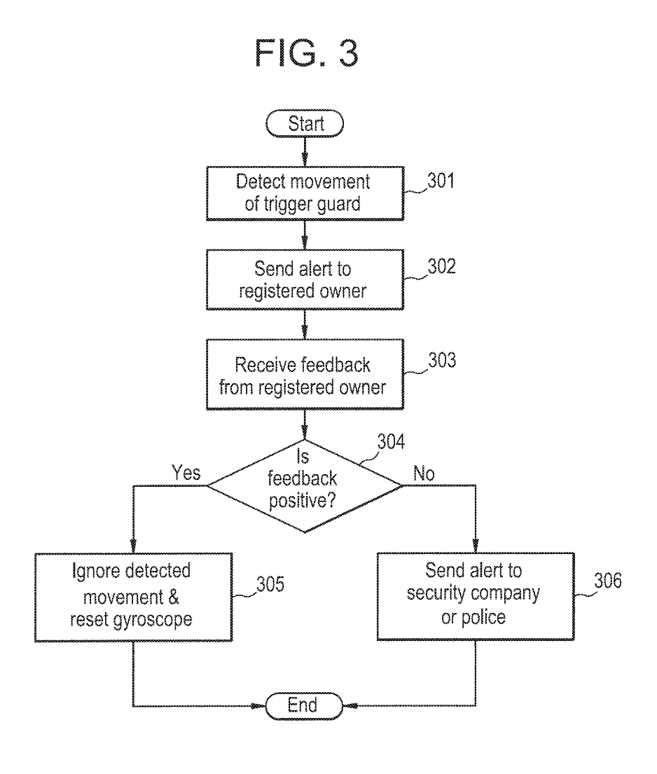

The different units within the communication and tracking module may comprise one or multiple processors. The communication unit 202 may incorporate Wi-Fi and/or Bluetooth technology and communicate different alerts (described below with reference to FIGS. 3-5) to a user device. The communication unit may further incorporate all possible means of short range and long range communication to communicate with user devices of the registered owner, the security company and the police.

The memory 203 may be used to store a set of fingerprints or other data required to hold information pertaining to authorized users to authenticate them during the unlocking process.

The GPS 204 is able to detect the location of the trigger guard lock and, using the communication unit, is able to communicate the position to the user device, the security company and/or the police.

The gyroscope 205 is capable of detecting any sort of movement of the trigger guard lock 100 and based on the preferences set by the user, is able to send alerts to the firearm owner's communication device, security company and/or the police.

The audio/video output unit is capable of sounding an alarm or flash out beams of light based on feedback of the user in response to alerts received form the trigger guard lock 100. This alert process and the feedback process is described in further detail below with reference to FIGS. 3-5.

FIG. 3 illustrates a flowchart depicting the detection and notification process of the trigger guard lock, according to an exemplary embodiment.

In step 301, the gyroscope 205 within the trigger guard lock 100 detects movement of the trigger guard lock. If the user preferences have been set to send an alert on any kind of movement, the communication unit 202 sends out an alert to a user device in step 302. In step 303 the trigger guard lock receives a feedback from the user regarding the alert.

A determination is made regarding whether user feedback is positive or negative in step 304. For example, if the user accidently moved the gun or a kid in the house moved the trigger lock or gun, the user might want to input a feedback ignoring the alert created because of such a movement. If the feedback is positive, the movement is ignored and the gyroscope 205 is reset in step 305.

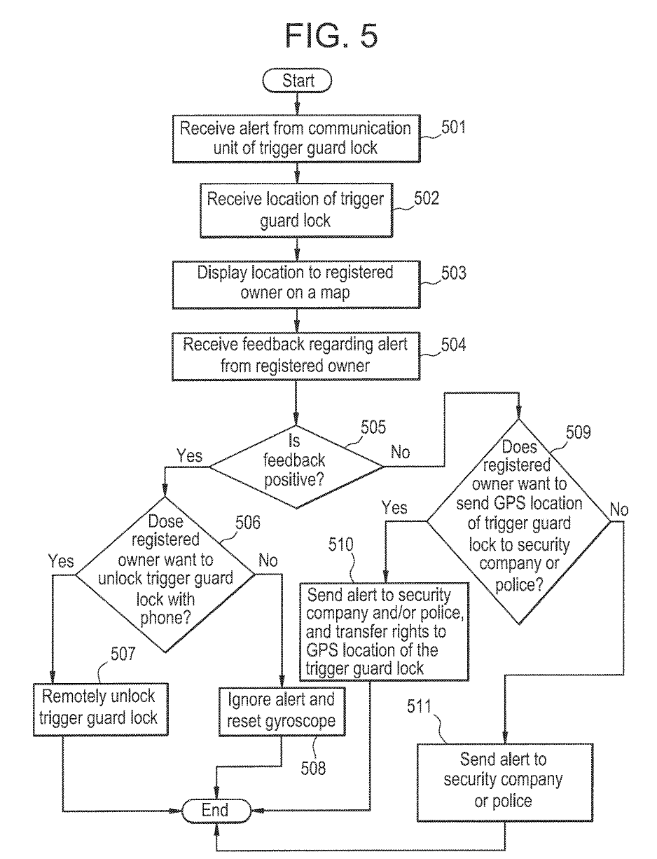

However, if the feedback is negative, the trigger guard lock's communication unit 202 may send out an alert directly to the police or to the security company in step 306, if the user preferences approve so. In such a situation, the user may take action to report the alert and GPS location of the trigger guard lock to the police from the user device as well, as will be explained below in greater detail with reference to FIG. 5.

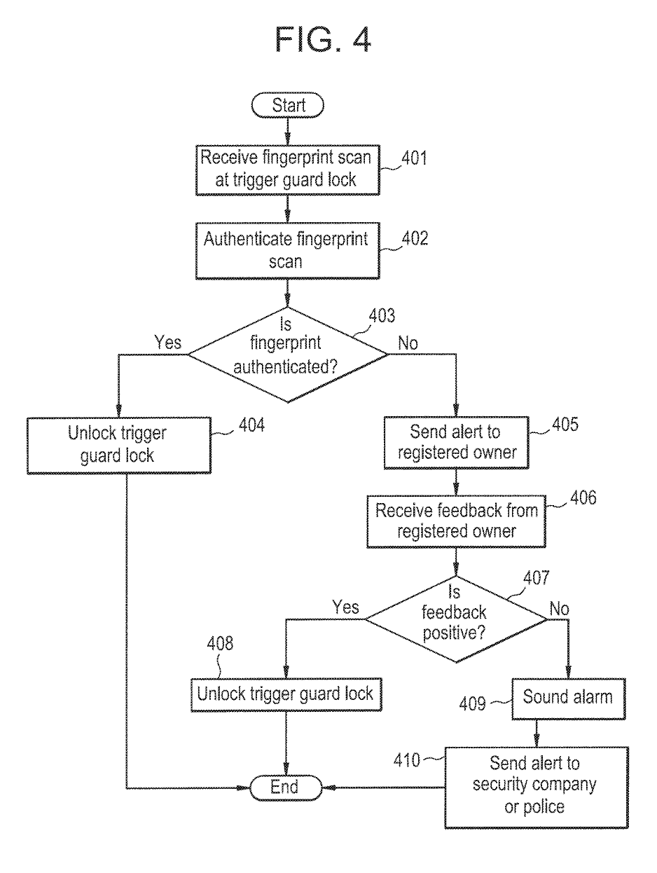

FIG. 4 illustrates a flowchart depicting the authentication and notification process of the trigger guard lock, according to an exemplary embodiment.

In step 401, the fingerprint scanner 105 received a fingerprint scan. In step 402, authentication of the fingerprint scan is conducted by comparing the received fingerprint with the stored authenticated fingerprints in the memory 203. It is determined if the fingerprints are authenticated in step 403. If it is determined that the fingerprints are authenticated, the trigger guard lock is unlocked in step 404 and the process ends.

However, if the fingerprint authentication is not successful, in step 405, the Communication unit 202 of the trigger guard lock 100 sends an alert to the user device. The alert may be in the form of an SMS, a voice call, or a notification on a dedicated application installed on the user device. The user responds to the alert, as described above, and the feedback from the user is received by the trigger guard lock 100 in step 406. In step 407, it is determined if the feedback is positive, the trigger guard is unlocked instep 408 and the process ends.

The user may send a positive feedback from the phone to unlock the trigger guard because the fingerprint scanner is malfunctioning, or if the user's hands are dirty and he/she is unable to get a clear scan. The user may generally unlock the trigger guard lock from the phone, via SMS or a dedicated application, without receiving an alert as well.

If, however, the feedback is negative in step 407, in step 409 the audio/video output unit 206 may sound an alarm and or output a flashing light, based on the user preferences set by the user. The communication unit 202 of the trigger guard lock 100 may further send an alert to the security company and/or the police in step 410, based on the feedback received from the user device and the user preferences.

It should be noted that the user preferences may be set using the preference selection unit 107 located on the trigger guard lock as well as from the user device, via SMS, voice call or using a dedicated application. According to another embodiment, the trigger guard lock may not incorporate the preference selection unit 107 at all and all settings and preferences may be managed via the user device.

FIG. 5 illustrates a flowchart depicting the control process of the trigger guard lock from a user device, according to an exemplary embodiment.

In step 501, the user device, mobile phone, computer, etc., receives an alert from the communication unit 202 of the trigger guard lock 100. The user device further receives, in step 502, the GPS location of the trigger guard lock from the trigger guard lock 100, the location sent via the communication unit 202 using the GPS 204.

The user device then displays the location of the trigger guard lock on a map to the user in step 503.

The user inputs the feedback, essentially informing the user device whether the alert is actually a threat or to be ignored, in step 504, and in step 505, it is determined if the feedback if positive or negative.

If it is determined that the feedback is positive, another determination is made regarding whether the user wants to unlock the trigger guard lock from the phone in step 506. The user may elect to remotely unlock the trigger guard lock 100 from the phone and upon such a selection, the trigger guard lock 100 is unlocked in step 507.

On the other hand, if the user elects not to remotely unlock, the alert is ignored and the gyroscope is reset in step 508.

If however, in step 505, the feedback is determined to be negative, it is determined, in step 509, whether the user wants to send the GPS location of the trigger guard lock 100 to a security company and/or the police. If the user chooses to forward the GPS location to the security company/police, the user device and/or the trigger guard may send the alert to the security company and/or the police, along with transferring rights to the GPS location of the trigger guard lock, in step 510.

On the other hand, if the user does not wish to transfer the GPS location of the trigger guard lock to the security company and/or police, the user device and/or the trigger guard lock sends an alert to the security company and/or police without transmitting the GPS location of the trigger guard lock in step 511.

The above application of the trigger guard lock may be applied to locks for any equipment other than firearms as well, such as locks for chests, laptops, safe deposit boxes, etc.

It should also be noted that the disclosure is illustrated and discussed herein as having a plurality of modules which perform particular functions. It should be understood that these modules are merely schematically illustrated based on their function for clarity purposes only, and do not necessary represent specific hardware or software. In this regard, these modules may be hardware and/or software implemented to substantially perform the particular functions discussed. Moreover, the modules may be combined together within the disclosure, or divided into additional modules based on the particular function desired. Thus, the disclosure should not be construed to limit the present invention, but merely be understood to illustrate one example implementation thereof.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a “data processing apparatus” on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

The various methods and techniques described above provide a number of ways to carry out the invention. Of course, it is to be understood that not necessarily all objectives or advantages described can be achieved in accordance with any particular embodiment described herein. Thus, for example, those skilled in the art will recognize that the methods can be performed in a manner that achieves or optimizes one advantage or group of advantages as taught herein without necessarily achieving other objectives or advantages as taught or suggested herein. A variety of alternatives are mentioned herein. It is to be understood that some embodiments specifically include one, another, or several features, while others specifically exclude one, another, or several features, while still others mitigate a particular feature by inclusion of one, another, or several advantageous features.

Particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

In closing, it is to be understood that the embodiments of the application disclosed herein are illustrative of the principles of the embodiments of the application. Other modifications that can be employed can be within the scope of the application. Thus, by way of example, but not of limitation, alternative configurations of the embodiments of the application can be utilized in accordance with the teachings herein. Accordingly, embodiments of the present application are not limited to that precisely as shown and described.

What is claimed is:

1) A method of detecting unauthorized use of a firearm owned by a registered user, performed by a trigger guard lock including at least one processor, the method comprising:
detecting, using at least one of said at least one processor, movement of the trigger guard lock;
transmitting, using at least one of said at least one processor, an alert to a user device informing the user of the detected movement;
receiving, using at least one of said at least one processor, a response to the transmitted alert from the user; and
unlocking, using at least one of said at least one processor, the trigger guard lock based on the received response.

2) The method of claim 1, further comprising:
if the response is negative, transmitting, using at least one of said at least one processor, an alert to at least one of a pre-designated security company and police; and
if the response is positive, unlocking, using at least one of said at least one processor, the trigger guard lock.

3) The method of claim 1, further comprising:
if the response is negative, sounding, using at least one of said at least one processor, an alarm.

4) The method of claim 1, wherein the transmitting the alert to the user device further comprises transmitting the GPS location of the trigger guard lock to the user device.

5) The method of claim 1 wherein the firearm is a gun.

6) A trigger guard lock comprising:
a gyroscope configured to detect movement of the trigger guard lock;
a communication unit configured to communicate with at least one user device;
a memory containing machine readable medium comprising machine executable code having stored thereon instructions for tracking the movements of the at least one object; and
a control unit comprising at least one processor coupled to the memory, the control unit configured to execute the machine executable code to cause the control unit to:
upon detection of movement of the trigger guard lock, transmit an alert to the at least one user device informing the user of the detected movement and receive a response to the transmitted alert from the at least one user device, and
unlock the trigger guard lock based on the received response.

7) The trigger guard lock of claim 6, wherein
if the response is negative, the communication unit further transmits an alert to at least one of a pre-designated security company and police; and
if the response is positive, the control unit unlocks the trigger guard lock.

8) The trigger guard lock of claim 6, further comprising:
an audio unit, configured to, if the response is negative, sound an alarm.

9) The trigger guard lock of clam 6, further comprising:
a global positioning system (GPS), wherein the communication unit, using the GPS, further transmits the GPS location of the trigger guard lock to the user device.

10) The trigger guard lock of claim 6, further comprising:
a fingerprint scanner configured to receive fingerprint scans from a user, wherein the memory is configured to store authorized fingerprints, and
the fingerprint scanner authenticates a fingerprint by comparing the fingerprint with fingerprints stored in the memory.

11) A method of controlling a trigger guard lock, using a device including at least one processor and a display, the method comprising:
receiving, using at least one of said at least one processor, an alert from the trigger guard lock;
displaying, on the display, the alert;
receiving, using at least one of said at least one processor, response from a user regarding the alert; and
transmitting, using at least one of said at least one processor, the response to the trigger guard lock.

12) The method of claim 11, further comprising:
receiving, using at least one of said at least one processor, GPS location of the trigger guard lock.

13) The method of claim 12, further comprising:
if the received response from the user is negative, transmitting, using at least one of said at least one processor, the received GPS location to at least one of a pre-selected security agency and police.
